(19) United States
(12) Patent Application Publication
(10) Pub. No.: US 2023/0250667 A1
(43) Pub. Date: Aug. 10, 2023

(54) DECORATIVE MEMORIAL FOR HOLDING CREMAINS

(71) Applicant: Thomas Clarke, Traverse City, MI (US)

(72) Inventor: Thomas Clarke, Traverse City, MI (US)

(21) Appl. No.: 18/081,110

(22) Filed: Dec. 14, 2022

Related U.S. Application Data
(60) Provisional application No. 63/306,521, filed on Feb. 4, 2022.

(51) Int. Cl. E04H 13/00; F21S 9/03

(52) U.S. Cl. CPC E04H 13/008; F21S 9/03

(57) ABSTRACT

A memorial such as for displaying cremain remains, including a superstructure defining an open interior. A removable top piece is attached atop the superstructure for permitting access to a cremain holding enclosure supported within the interior. The removable top piece includes any of a lamp, globe, planter or birdbath. A solar lighting element is incorporated into the removable top piece. A window is configured within the superstructure for viewing the internally held cremain holding enclosure. The enclosure further incorporates each of a bottom cap, sleeve shaped body and top cap. The bottom cap defines a platform for the cremain enclosure secured within the interior in order to array the cremain enclosure level with the viewing window.

### CROSS REFERENCE TO RELATED APPLICATIONS

The present application claims the priority of U.S. Ser. No. 63/306,521 filed Feb. 4, 2022.

### FIELD OF THE INVENTION

The present invention relates generally to burial memorials. More specifically, the present invention discloses a decorative burial memorial substituting for prior art urns or vessels for holding cremains, the decorative memorial being placed in any of an indoor or outdoor location. The cremains are held within a separate enclosure removably mounted within the memorial which can be viewed through one or more windows configured in a superstructure of the assembly. A further removable top piece can include, without limitation, any of a lamp, globe, planter, birdbath, or the like and which, upon removal, allows easy access to the separate enclosure holding the cremains.

### BACKGROUND OF THE INVENTION

The prior art is documented with numerous examples of burial urns vessels for holding such as cremains. Traditionally, such enclosures have been associated with cemeteries or mausoleums however, and in more recent years, the ability to safely and attractively store and display/present the decedent' cremains has gained popularity. This can also include presentation in memorial niches as well as in residential settings.

Examples of known cremation containers include U.S. Pat. No. 5,903,961, disclosing a combination lawn/garden ornament and cremation container. U.S. Pat. No. 7,272,874 teaches a cremation urn convertible into a birdhouse, with U.S. Pat. No. D920,621 disclosing a funerary urn.

### SUMMARY OF THE PRESENT INVENTION

The present invention discloses a memorial such as for displaying cremain remains, including a superstructure defining an open interior. A removable top piece is attached atop the superstructure for permitting access to a cremain holding enclosure supported within the interior.

The removable top piece can include any of a lamp, globe, planter or birdbath. Other features include a solar lighting element incorporated into the removable top piece for illuminating, such as during periods of darkness.

At least one viewing window is configured within the superstructure for viewing the internally held cremain holding enclosure. In one non-limiting construction, the superstructure further includes a plurality of inter-assembled and beveled staves.

The enclosure further incorporates each of a bottom cap, sleeve shaped body and top cap. The bottom cap defines a platform for the cremain enclosure secured within the interior in order to array the cremain enclosure level with the viewing window.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a decorative memorial according to a non-limiting embodiment of the present invention;

FIGS. 2A-2D present a series of views of a bottom cap component of a cremain holding enclosure forming a part of the present invention;

FIGS. 3A-3D presents a series of views of a PVC cylinder component forming a further portion of a cremain holding enclosure according to the present invention;

FIGS. 4A-4D presents a series of views of a stave cone component forming a main body of the present invention;

FIGS. 5A-5D presents a series of views of a PVC top cap for use with the PVC cylinder and bottom cap for constructing the inner cremain holding enclosure supported within the memorial assembly;

FIGS. 6A and 6B present a pair of rotated perspective views of a tapered staves incorporated into an outer upwardly extending superstructure of the cremain memorial as depicted in the non-limiting variant of FIG. 1; and

FIG. 7 presents a transparent line art view in perspective of the tapered or cone shaped outer body and depicting in solid the interior cremain supporting enclosure including each of the PVC cap, PVC cylinder, and bottom cap components which are supported within the outer body of the memorial, such as created by the tapered staves.

### DETAILED DESCRIPTION OF THE PREFERRED EMBODIMENTS

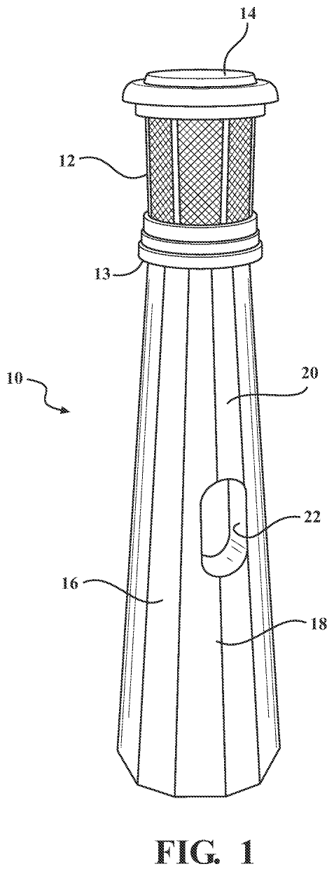

With reference to the attached illustrations, the present invention discloses a decorative burial memorial, see generally at 10 in FIG. 1, such substituting for prior art urns or vessels for holding cremains, and which can be placed in any indoor or outdoor location. As previously described, the cremains are held within a separate enclosure (collectively defined in the illustrations in one non-limiting variant as including a sleeve with enclosing top and bottom caps) removably mounted within the memorial, and which can typically be viewed through a window configured in a superstructure of the memorial and assembly.

As again shown in the perspective view of FIG. 1, the decorative memorial 10 includes a further removable top piece 12 which can include, without limitation, any of a lamp (as shown), globe, planter, birdbath, or the like and which, upon removal, allows easy access to the separate interior supported enclosure holding the cremains. A solar or other lighting element 14 can be incorporated into the removable top piece 12 for decorative effect, and such as to cause any associated decorative element to illuminate during periods of darkness.

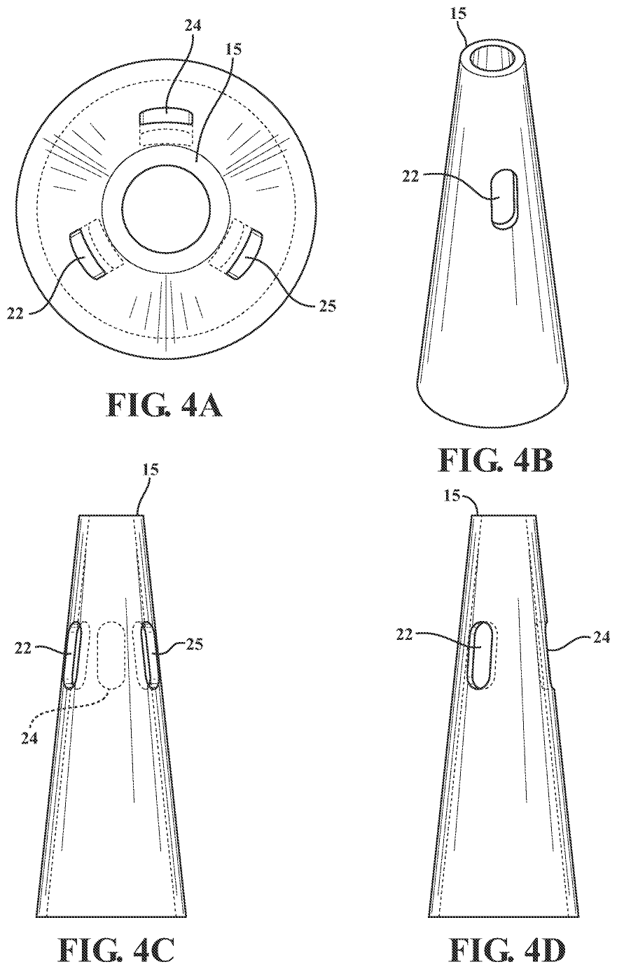

The removable top piece 12 is dimensioned so that it includes a bottom annular support surface 13 (see again FIG. 1), which can be secured to a circular rim aperture 15 (see FIGS. 4A-4D) defining a top of the main cone or tapered superstructure. Any means of attachment is envisioned, not limited to the use of bolt or screw fasteners, bayonet tab and slot attachment portions, or opposing and inter-engaging thread patterns established between the mating annular surfaces of the top piece 12 and main supporting body or superstructure.

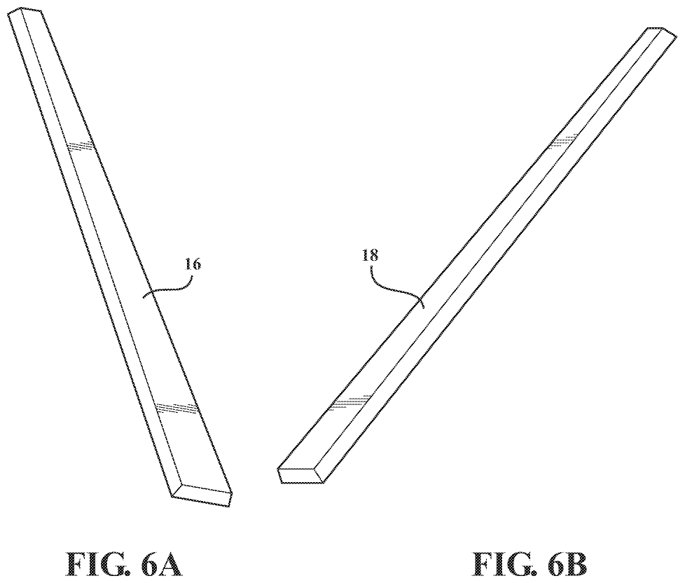

As also shown in the views of FIGS. 6A and 6B, a plurality of elongated and cross sectionally tapered staves 16, 18, 20, et. seq. are provided in one non-limiting variant, which are inter-assembled in order to create the decorative outer shell, superstructure or monument. Without limitation, the staves 16, 18 and 20 can be constructed of any suitable material (such preferably exhibiting weatherproof properties) and which, upon assembly, define a generally open (i.e. typically conical shaped) interior. This can include joining the respective staves along their elongated beveled edges (such including without limitation having side and end bevel angled edges at fifteen and six degrees) to define the general overall profile of FIG. 1.

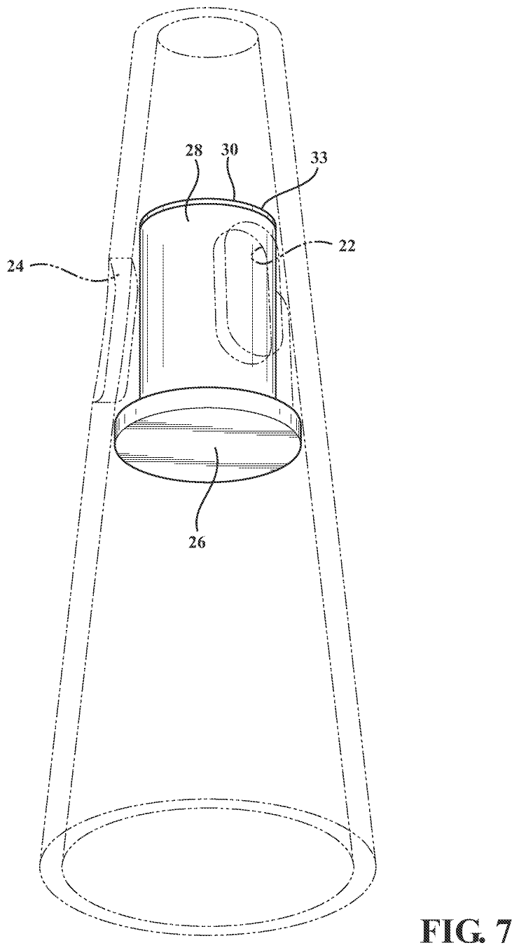

It is also envisioned that the conical shaped body of the superstructure can be formed from a single continuous piece, such as through milling in the case of natural (e.g. wooden or cellulosic) materials, as well as the creation of the shell through such as an injection molding or casting process in the instance of forming the outer shell of the body or memorial utilizing a synthetic plasticized or faux wooden appearing material (see again the general representation of the conical shaped shell in FIG. 7, which can include any other shape or design not limited to that shown which is suitable for holding the interior cremain enclosure.

Also depicted in each of FIGS. 1, 4A-4D and 7 is the formation of one or more window defining apertures (see at 22, 24, 25 et seq. in FIG. 4 in one non-limited application) can be formed within the superstructure, these being in general alignment with the cremain enclosure in order to provide visibility to the interiorly supported and removable interior enclosure. The window defining apertures can include any desired shape not limited to the elongated and rounded profile depicted and in order to provide continuous viewing of the cremains. Although not shown, this can also include mounting transparent viewing windows to the inner supporting rim edges of the apertures and in order to provide environmental sealing of the interior supported cremain enclosure from the outside elements.

Without limitation, the window aperture profiles can be either pre-formed or post-machined into the individual elongated staves 16, 18, 20, et. seq. at any point before, during or after assembly, and which is further. It is also envisioned that the window profiles can be modified from the capsule like configuration shown for utilization in alternate variants and can also include forming an annular ring shaped structure, such as a transparent viewing window, and such as which can be incorporated into a one piece superstructure.

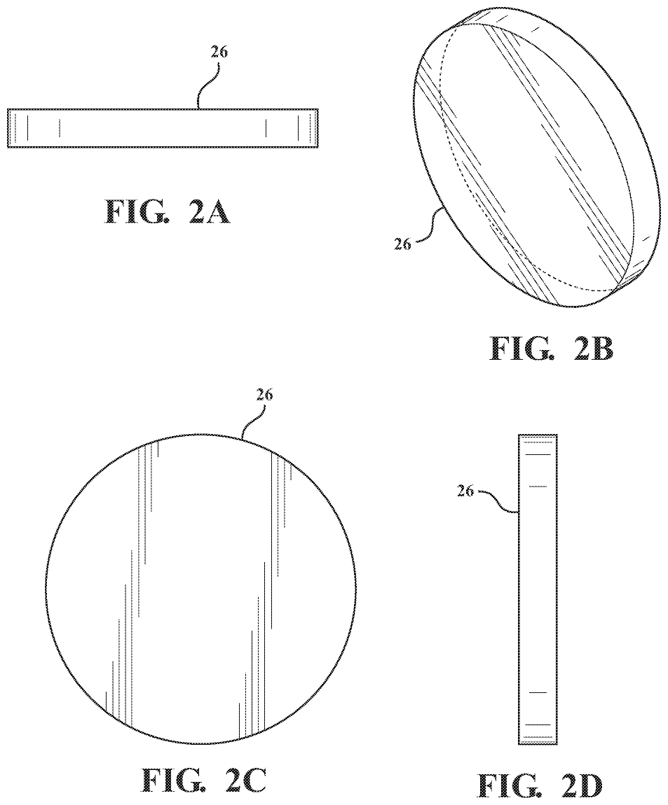

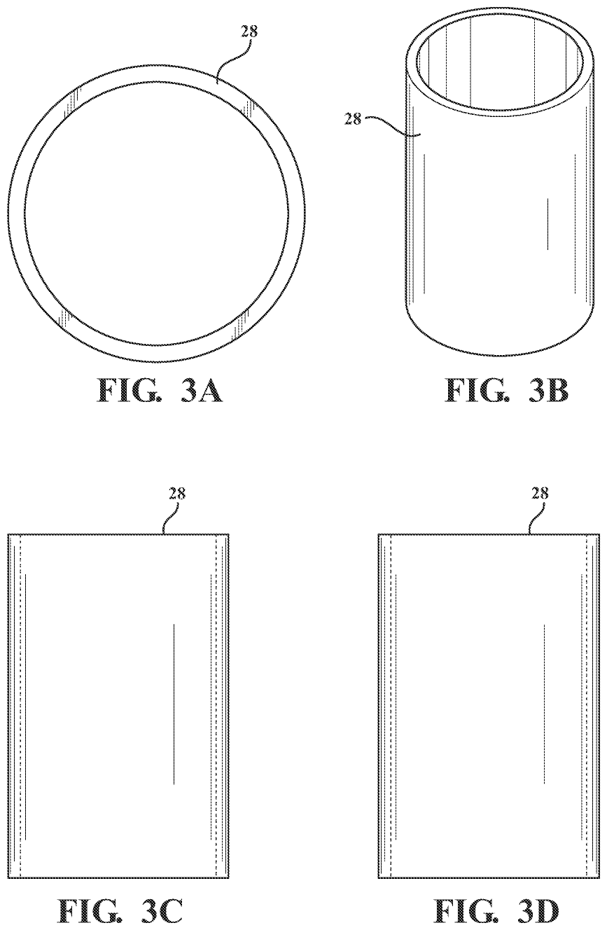

FIGS. 2A-2D presents a series of line art views of a bottom cap component 26 forming a part of the present invention (this depicted in solid in the installation view of FIG. 7). FIGS. 3A-3D presents a series of line art views of a cylinder 28 component (such as without limitation constructed of a polyvinyl or PVC construction) forming a further part of the present invention.

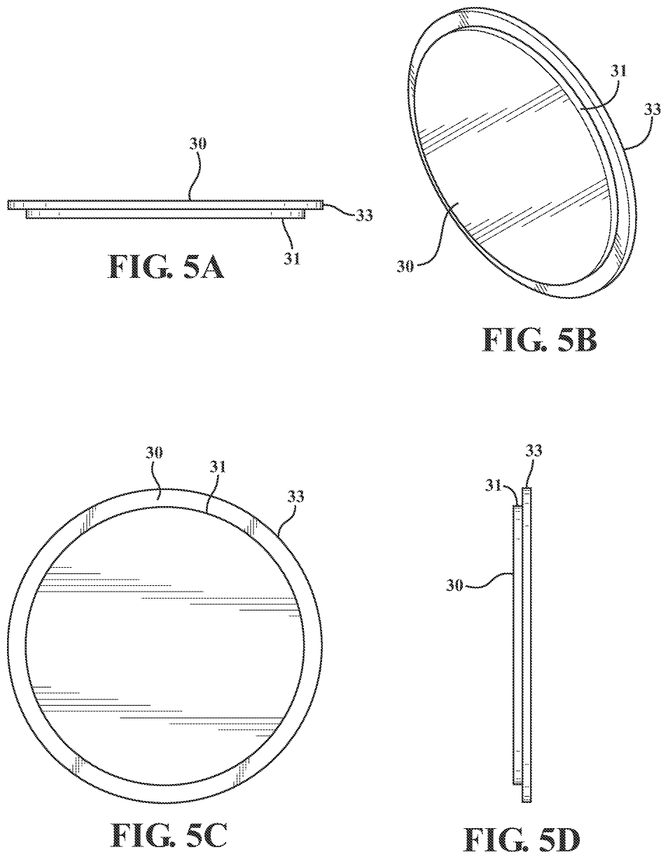

FIGS. 5A-5C present a series of line art views of an upper or top cap 30 (such as again PVC constructed) for use with the PVC cylinder 28 and bottom cap 26 for constructing the inner cremain holding enclosure supported within the memorial assembly. The top cap 30 can include inner 31 and outer 33 diameter defined rim layers for facilitating a snug assembly over the opposing top annular surface of the main enclosure cylinder 28. Without limitation, the bottom cap 26 can be affixed within the interior of the memorial superstructure as shown in the line art view of FIG. 7 in order to define a platform for supporting the enclosure in alignment with the viewing windows.

Finally, FIG. 7 presents a transparent line art view in perspective and showing each of the PVC cap 30, PVC cylinder 28, cone (staves 16, 18, 20, et seq.) and bottom cap 26 components defining the interior and removably supported cremain enclosure. Beyond that shown in FIGS. 2, 3, 5 and 6, the cremain enclosure can include any alternate construction and the memorial superstructure can be further modified in order to accommodate a variety of different existing cremain enclosures.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A memorial such as for displaying cremain remains, comprising:
a superstructure defining an open interior; and
a removable top piece for permitting access to a cremain holding enclosure supported within said interior.

2. The memorial of claim 1, said removable top piece further comprising any of a lamp, globe, planter or birdbath.

3. The memorial of claim 2, further comprising a solar lighting element incorporated into said removable top piece for illuminating during periods of darkness.

4. The memorial of claim 1, further comprising at least one viewing window configured within said superstructure for viewing said cremain holding enclosure.

5. The memorial of claim 1, said superstructure further comprising a plurality of interassembled and beveled staves.

6. The memorial of claim 4, said enclosure further comprising each of a bottom cap, sleeve shaped body and top cap.

7. The memorial of claim 6, further comprising said bottom cap defining a platform for said cremain enclosure and being secured within said interior in order to array said cremain enclosure level with viewing window.

8. A memorial such as for displaying cremain remains, comprising:
a superstructure defining an open interior, said superstructure further including a plurality of interassembled and beveled staves;
at least one viewing window configured within said superstructure for viewing a cremain holding enclosure; and
a removable top piece for permitting access to said cremain holding enclosure supported within said interior.

9. The memorial of claim 8, said removable top piece further comprising any of a lamp, globe, planter or birdbath.

10. The memorial of claim 9, further comprising a solar lighting element incorporated into said removable top piece for illuminating during periods of darkness.

11. The memorial of claim 8, said enclosure further comprising each of a bottom cap, sleeve shaped body and top cap.

12. The memorial of claim 11, further comprising said bottom cap defining a platform for said cremain enclosure and being secured within said interior in order to array said cremain enclosure level with viewing window.

13. A memorial such as for displaying cremain remains, comprising:
a superstructure defining an open interior;
a removable top piece for permitting access to a cremain holding enclosure supported within said interior;
said enclosure further including each of a bottom cap, sleeve shaped body and top cap; and
a solar lighting element incorporated into said removable top piece.

14. The memorial of claim 13, said removable top piece further comprising any of a lamp, globe, planter or birdbath.

15. The memorial of claim 13, further comprising at least one viewing window configured within said superstructure for viewing said cremain holding enclosure.

16. The memorial of claim 13, said superstructure further comprising a plurality of interassembled and beveled staves.

17. The memorial of claim 13, further comprising said bottom cap defining a platform for said cremain enclosure and being secured within said interior in order to array said cremain enclosure level with viewing window.
